(19) United States
(12) Patent Application Publication
(10) Pub. No.: US 2012/0323698 A1
(43) Pub. Date: Dec. 20, 2012

(54) Interface for Online Advertising

(76) Inventor: William S. Disman, San Diego, CA (US)

(21) Appl. No.: 13/160,153

(22) Filed: Jun. 14, 2011

(51) Int. Cl. G06Q 30/02

(52) U.S. Cl. 705/14.67

(57) ABSTRACT

A system and method for presenting advertisements online to a user involves an interface that interacts with a user to develop a user profile. Specifically, the user profile, which is jointly created by the user and the interface, will include a plurality of personalized indicators that pertain to an identifiable behavior, or behaviors, of the user. A customer profile is also created by the interface, with a product/service provider (i.e. advertiser), that includes product/service presentations directed to predetermined customer demographics. The interface then weighs the product/service presentations in the customer profile according to a relative pertinence of indicators in the user profile, and matches a customer profile with a user profile to select a pertinent advertisement. The pertinent advertisement is then personalized and presented on a web site for exclusive viewing by the user.

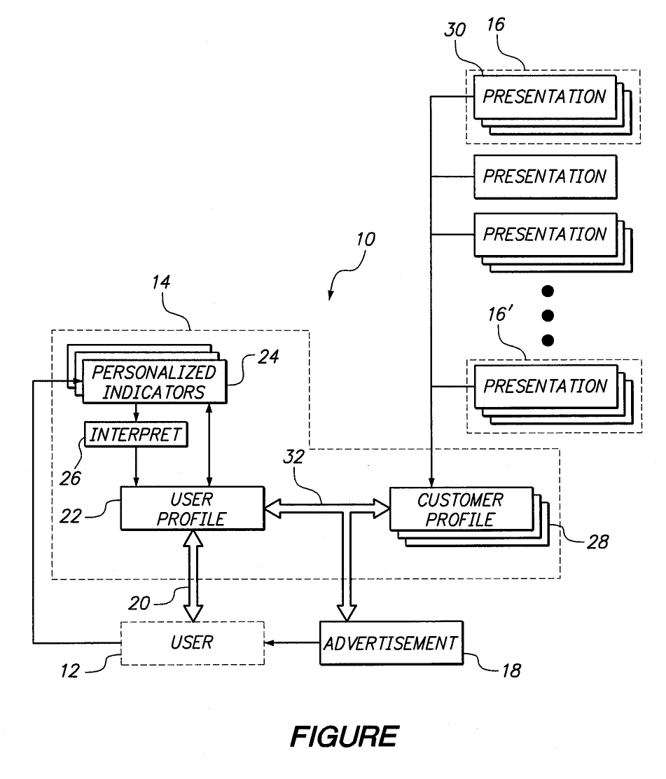

### FIELD OF THE INVENTION

The present invention pertains generally to online advertising. More particularly, the present invention pertains to systems and methods for creating customized and personalized advertisements for a user of a product/service that is being advertised. The present invention is particularly, but not exclusively, useful as a system and method for online advertising, wherein an interface creates an advertisement from a product/service provider based on direct interactive input from the potential product/service user.

### BACKGROUND OF THE INVENTION

In general, advertising has heretofore been typically a unidirectional activity. Essentially, the product/service provider has described his/her product/service in an attractive and enticing manner, and has then used the resultant description for an advertisement in whatever venue the product/service provider considers appropriate. Thereafter, consumer response has been primarily happenstance.

It has happened in recent years that various online services available on the Internet have become particularly convenient venues for advertising, in that they allow for new and innovative advertising techniques. For example, with a so-called “blast,” an advertiser on the Internet is able to simultaneously present his/her product/service to a plethora of different persons. A persistent problem, however, has been that such “blasts,” as well as more pointed advertising, are often disruptive, irritating and essentially meaningless to many recipients of the advertising. Unfortunately, this can be counterproductive to the interests of the product/service provider (advertiser) as well as the potential product/service user.

With the above in mind, and in an effort to efficiently and effectively focus on the more likely customers of a product/service, the advertisers have undertaken to develop customer profiles that are primarily based on customer demographics. This effort, in large part, has been possible due to the ability of an advertiser to monitor the electronic activity of a potential customer on the Internet. Consequently, based on this activity, an advertiser has been able to narrow advertising efforts to a more relevant market. Nevertheless, the advertising effort has remained essentially unidirectional.

In light of the above, it is an object of the present invention to provide a system and method for presenting online advertisements to a user that will allow the user, as a potential online customer, to create, modify, and revise a specific user profile for determining the content and type of advertisements that are acceptable to the user. Another object of the present invention is to provide a system and method for presenting online advertisement that use an interface to establish compatibility between a user profile that is controlled by the user, and a customer profile that is based on input from an advertiser. Still another object of the present invention is to provide a system, and its method of use, for presenting online advertisements that are simple to use, are easy to implement and are comparatively cost effective.

### SUMMARY OF THE INVENTION

In accordance with the present invention, a system and methods for presenting online advertisements to a user allow the user to interact directly with an interface. This interaction results in the development of a user profile.

In addition to the user profile, the system and methods of the present invention also require the interface to work with a product/service provider(s) to create a customer profile(s). Once the profiles have been created, the interface will then work with the user profile, and with the customer profile(s), to select a pertinent advertisement that can be personalized and presented to the user for consideration.

For the development of a user profile, it is important that the user is able to selectively interact with the interface. Specifically, through this interaction, information is transferred from the user to the interface for evaluation of the information by the interface. Importantly, the user is able to modify, revise, alter or change the information by addition or deletion at any time. The interface will then evaluate the information and focus on a plurality of personalized indicators in the information that pertain to an identifiable behavior(s) of the user. For the present invention, an identifiable behavior of the user may include a purchasing behavior of the user, a behavior of the user that is inferentially interpreted by the interface, or both.

As envisioned for the present invention, each of the personalized indicators that are gleaned from the information provided by the user will be based primarily on personal characteristics and physical attributes of the user. For example, these personal characteristics may be based on considerations such as the user's likes and dislikes; his/her trends and tendencies; geographical notes; background information (education, income history, family, health, employment and religion); and general interests (sports, food, travel, art and literature). It is to be appreciated that additional personal characteristics of the user can also be interpreted by the interface. Specifically, this interpretation can be done by evaluating otherwise apparently unrelated information provided by the user. For instance, the interface is capable of cross referencing each personal characteristic with at least one other personal characteristic. This cross reference can then be used to interpret and clarify the cross referenced characteristics for use in creating another personalized indicator for the user profile. In the event, it is a crucial and important aspect of the present invention that the user be able to directly, and indirectly, interact with the interface for the development of the user profile.

For the creation of a customer profile, the interface works directly with a product/service provider (i.e. the advertiser). More specifically, the customer profile will include presentations of product(s)/service(s) that are directed to customer demographics. Primarily, these product/service presentations will include applicable considerations of product price point; seasonal interest of the product/service; time of day considerations; nature of goods and services; customer age; and customer geographic location.

Once the user profile and the customer profile(s) have been assembled at the interface, the interface can then weigh the product/service presentations in the customer profile according to their relative pertinence to indicators in the user profile. The customer profile can then be matched with the user profile to select a pertinent advertisement. After the selection of a pertinent advertisement, the advertisement can be personalized for the user and presented online to the user for his/her information. As envisioned for the present invention, the advertisement will most likely be electronically presented on a web site.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which the FIGURE is a functional schematic for the interactive aspects of the system and methods of the present invention.

### DESCRIPTION OF THE PREFERRED EMBODIMENTS

Referring to the FIGURE, a functional schematic for a system in accordance with the present invention is shown and is generally designated 10. As shown, the system 10 is provided to establish specified, online communication links between a user 12, an interface 14 and a product/service provider 16. As envisioned for the present invention, these communication links will be made electronically through the interface 14, and most likely over the now well known Internet. Although the FIGURE specifically identifies only a product/service provider 16 and a product/service provider 16′, these identifications are exemplary. Thus, it is to be appreciated that a plethora of such providers 16 are envisioned for the present invention. Also, although only a single user 12 is indicated, it is also to be appreciated that a plethora of users 12 may actually be using the system 10 at any one time. Indeed, there will likely be many more users 12 than there are product/service providers 16. There will, however, be only one interface 14. With this in mind, the FIGURE is presented to indicate how a single interface 14 can service one of many users 12, that will each be placed in a continuous online communication with all of the participating product/service providers 16. From another perspective, the product/service providers 16 are each an advertiser of their respective product(s)/service(s). And, the user 12 is merely an online party that is the intended recipient of electronic advertisements 18 (i.e. user 12 is a potential customer).

The two-way arrow 20 in the FIGURE indicates that a user 12 will interact directly with the interface 14 to develop a user profile 22. Importantly, the interaction between the user 12 and interface 14 is a continuous activity, and it includes both the direct and the indirect transfer of information. In particular, the interface 14 will use information from the user 12 to generate, and update, personalized indicators 24 that are characteristic of the user 12 and will be used for development of the user profile 22.

As an example of a direct information transfer, the information that is transferred from the user 12 to the interface 14 will include personal characteristics and physical attributes of the user 12, such as his/her expressed likes and dislikes; trends and tendencies; geographical notes; background information (education, income history, family, health, employment and religion); and general interests (sports, food, travel, art and literature). Such information can be used directly to create personalized indicators 24 for the user 12. On the other hand, for an indirect transfer of information, block 26 indicates that indicators 24 can also be inferred or interpreted. This is possible due to the capability of the system 10 to cross reference each personal characteristic of a user 12 with at least one other personal characteristic of that user 12. Based on this cross referencing, additional personalized indicator(s) 24 can be created for inclusion in the user profile. Accordingly, regardless how the personalized indicator 24 is created, it will be included in the user profile 22.

The FIGURE further indicates that the interface 14 also manages a plurality of customer profiles 28. In detail, each product/service provider 16 that is participating in the operation of system 10 will create its own product/service presentation(s) 30. Typically, each presentation 30 will include information about the particular product/service that is to be advertised, and will also include such information as product price point; seasonal interest of product; time of day considerations; nature of goods and services; customer age; and customer geographic location, to name a few. In the event, a product/service provider 16 can provide as many product/service presentations 30 as desired, and the interface 14 will appropriately incorporate them into a customer profile 28.

The three-way arrow 32 shown in the FIGURE indicates an operation of the system 10 wherein the user profile 22 and appropriate customer profiles 28 have already been created. At this point, when a user 12 goes online, the interface 14 is notified of this by the system 10. The interface 14 will then identify and selectively retrieve indicators 24 from the user profile 22 that are pertinent to product/service presentations 30 in the customer profiles 28. Preferably, these indicators 24 have been weighted by the interface 14 in order to match the most pertinent indicators 24 from the user profile with specific product/service presentations 30. Based on the matching of indicators 24 and product/service presentations 30, the interface 14 is then able to present specific advertisements 18 to the user 12. Further, these advertisements 18 can be personalized for the user 12. Although other online capabilities may be used, the present invention envisions an electronic presentation of the advertisement 18 on an Internet web site.

While the particular Interface for Online Advertising as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for presenting advertisements to a user which comprises the steps of:
developing a user profile, wherein the user profile includes a plurality of personalized indicators pertaining to an identifiable behavior of the user;
interacting with the user for a transfer of information during the developing step;
creating a customer profile, wherein the customer profile includes product/service presentations directed to predetermined customer demographics;
weighting the product/service presentations in the customer profile according to a relative pertinence of indicators in the user profile;
matching a customer profile with a user profile to select a pertinent advertisement; and
presenting the advertisement for exclusive viewing by the user.

2. A method as recited in claim 1 further comprising the step of allowing the user to selectively bypass the interacting step.

3. A method as recited in claim 1 wherein the indicators are based on personalized characteristics and physical attributes of the user obtained during the developing step.

4. A method as recited in claim 3 wherein personalized characteristics of the user include applicable considerations of the user for: likes and dislikes; trends and tendencies; geographical notes; background information (education, income history, family, health, employment and religion); and general interests (sports, food, travel, art and literature).

5. A method as recited in claim 4 further comprising the step of cross referencing each personalized characteristic with at least one other personalized characteristic for interpreting and clarifying the cross referenced characteristics for use in creating a personalized indicator.

6. A method as recited in claim 1 wherein product/service presentations include applicable considerations of: product price point; seasonal product interest; time of day considerations; nature of goods and services; customer age; and customer geographic location.

7. A method as recited in claim 1 further comprising the steps of:
identifying the indicators in the user profile; and
selectively retrieving indicators from the user profile, based on the identifying step, for use in the matching step.

8. A method as recited in claim 1 wherein the advertisement is electronically presented on a web site.

9. A method as recited in claim 1 further comprising the step of personalizing the advertisement for the user.

10. A method as recited in claim 1 wherein the identifiable behavior of the user includes a purchasing behavior and an interpreted behavior.

11. A method performed by a user for soliciting a personalized online advertisement, the method comprising the steps of:
providing personal information about the user to an interface for creation of a user profile, wherein the user profile includes a plurality of personalized indicators pertaining to an identifiable behavior of the user;
evaluating the user profile;
interacting with the interface to revise the user profile; and
receiving advertisements from a product/service provider based on a compatibility analysis conducted by the interface, wherein the compatibility analysis results from a comparison of the user profile with a customer profile, and wherein the customer profile includes product/service presentations presented to the interface by the product/service provider.

12. A method as recited in claim 11 wherein the interacting step comprises the steps of:
modifying the user profile;
altering the user profile; and
revising the user profile.

13. A method as recited in claim 11 wherein the compatibility analysis conducted at the interface comprises the steps of:
weighting the product/service presentations in the customer profile according to a relative pertinence of indicators in the user profile;
matching a customer profile with a user profile based on the weighting step to select a pertinent advertisement.

14. A method as recited in claim 11 wherein the advertisement is electronically presented on a web site.

15. A method as recited in claim 11 wherein the identifiable behavior of the user includes a purchasing behavior and an interpreted behavior, wherein the interpreted behavior is identified by the interface.

16. A system for presenting online advertisements to a user which comprises:
a user profile, wherein the user profile includes a plurality of personalized indicators pertaining to an identifiable behavior of the user;
a customer profile, wherein the customer profile includes product/service presentations directed to predetermined customer demographics;
an interface site for weighting the product/service presentations in the customer profile according to a relative pertinence of indicators in the user profile, and for matching the customer profile with the user profile to select a pertinent advertisement; and
a means for presenting the advertisement for exclusive viewing by the user.

17. A system as recited in claim 16 wherein there are a plurality of customer profiles and each customer profile is based on a plurality of unique product/service presentations.

18. A system as recited in claim 17 wherein the plurality of product/service presentations includes a plurality of bundles of product/service presentation, and wherein each bundle of product/service presentations is created by a single product/service provider.

19. A system as recited in claim 16 wherein the advertisements are electronically presented on a web site.

20. A system as recited in claim 16 wherein the advertisements for the user are personalized.
